(19) United States
(12) Patent Application Publication
(10) Pub. No.: US 2020/0266944 A1
(43) Pub. Date: Aug. 20, 2020

(54) WIRELESS COMMUNICATION METHOD AND USER EQUIPMENT FOR RESOURCE ELEMENT MAPPING WITH FREQUENCY HOPPING

(71) Applicant: NTT DOCOMO, INC., Tokyo (JP)

(72) Inventors: Yuichi Kakishima, Tokyo (JP); Shohei Yoshioka, Tokyo (JP); Kazuki Takeda, Tokyo (JP); Satoshi Nagata, Tokyo (JP)

(73) Assignee: NTT DOCOMO, INC., Tokyo (JP)

(21) Appl. No.: 16/651,500

(22) PCT Filed: Sep. 28, 2018
(86) PCT No.: PCT/US2018/053267

§ 371 Date: Mar. 27, 2020

Related U.S. Application Data
(60) Provisional application No. 62/565,684, filed on Sep. 29, 2017.

(51) Int. Cl. H04L 5/00; H04B 1/713

(52) U.S. Cl. CPC H04L 5/0012; H04L 5/0044; H04B 1/713

(57) ABSTRACT

A wireless communication method includes performing, with a user equipment (UE), resource element (RE) mapping with frequency hopping. Multiple code blocks (CBs) are mapped to REs in a first sub-slot and a second sub-slot in accordance with a ration of a first sub-slot length of the first sub-slot to a second sub-slot length of the second sub-slot. The first and second sub-slot lengths are a number of Orthogonal Frequency-Division Multiplexing (OFDM) symbols that can multiplex a Physical Uplink Shared Channel (PUSCH). The first and second sub-slot lengths are a number of REs that can multiplex a PUSCH. Each of the multiple CBs is continuously mapped to the REs in a same OFDM symbol. Different CBs are mapped to the REs in a same OFDM symbol.

### TECHNICAL FIELD

One or more embodiments disclosed herein relate to a wireless communication method of a resource element (RE) mapping scheme and a user equipment that performs the RE mapping.

### BACKGROUND

In Long Term Evolution (LTE)/LTE-Advanced (LTE-A), a transmission signal is divided into multiple codewords (CWs) and each of CWs is further composed of multiple codeblocks (CBs). The CW is a unit of re-transmission (HARQ: Hybrid ARQ). An LTE/LTE-A packet (CW mapping) has been designed to achieve Multiple-Input and Multiple-Output (MIMO) spatial diversity gain. Specifically, a modulated signal sequence is mapped in order of MIMO layer, subcarrier (frequency), and Orthogonal Frequency-Division Multiplexing (OFDM) symbol (time).

In New Radio (NR) (fifth generation (5G)), intra-slot frequency hopping is introduced to achieve frequency diversity gain. In the intra-slot frequency hopping for an uplink data channel (Physical Uplink Shared Channel (PUSCH)), a single slot is divided into different resource blocks (RBs) and a CB is mapped across hopping resources in the different RBs. An example of resource element (RE) mapping of PUSCH transmission with intra-slot frequency hopping will be described below, with reference to FIGS. 1A-1C.

In an example of FIG. 1A, there are two CBs #0 and #1 of which length is n bits. In an example of FIG. 1A, the length “n” is “E” bits. In FIG. 1A, a bit number (e.g., 1, 2, 3, 4, 5, . . . , E) is labeled in each of the CB #0 and #1 to explain a procedure of RE mapping.

In FIG. 1B, a horizontal axis represents a time (OFDM symbol) axis, a vertical axis represents a frequency (subcarrier) axis, and each block represents an RE. In FIG. 1B, the number of the OFDM symbols in a time axis direction of a single slot is 14. For the intra-slot frequency hopping in conventional technologies such as the LTE/LTE-A standards, the single slot is divided into two sub-slots (first and second sub-slots) so that OFDM symbol length of the first and second sub-slots is equal. In an example of FIG. 1B, each of the first and second sub-slots has 7 OFDM symbols. In FIG. 7B, the number labeled on each RE represents the bit number in FIG. 1A and order of REs mapped to each of the CBs #0 and #1. As shown in FIG. 1B, the REs for the CB #0 are mapped in the order of frequency resources and time resources with hopping to the different sub-slot, and then the REs for the CB #1 are mapped in a similar manner to the RE mapping for the CB #0.

As a result of the RE mapping with intra-slot frequency hopping, as shown in FIG. 1C, frequency resources used for the REs in the first and second sub-slots are different from each other.

Thus, in the RE mapping of PUSCH transmission with intra-slot frequency hopping in the conventional technologies, a single slot is divided into multiple sub-slots so that the number of mapping REs of each sub-slot is equal (or at least similar).

However, when the OFDM symbol length of each sub-slot or the number of REs in each sub-slot is different, if the above conventional method of RE mapping with intra-slot frequency hopping is applied to multiple CBs, all or part of multiple CBs may be mapped to only one of a plurality of sub-slots.

For example, as shown in FIGS. 2A and 2B, the OFDM symbol length of a first sub-slot is different from the OFDM symbol length of a second sub-slot. In examples of FIGS. 2A and 2B, the first and second sub-slots have 10 and 4 OFDM symbols, respectively.

As shown in FIG. 2A, the CB #0 may be mapped to the REs in the first sub-slot only when the RE mapping is performed based on the conventional method in FIGS. 1B and 1C.

As shown in FIG. 2B, when the CW #0 (CW #1) is mapped to the REs in a certain OFDM symbols in the first sub-slot, and then mapped to the REs in a certain OFDM symbols in the second sub-slot, the CB #2 may be mapped to the REs in the first sub-slot only.

As a result, for the CB mapped to the REs in only one of the sub-slots, frequency diversity gain using frequency hopping is not achieved and a characteristics of diversity gain (transmission quality) for the CB is degraded. Furthermore, if there is a variation in the characteristics of diversity gain in a plurality of CBs, in a NR system where ACK/NACK is transmitted in each a Transport Block (TB) or a Code Block Group (CBG), characteristics of a plurality of CBs may be aligned with the degraded characteristics of one of a plurality of CBs.

However, when the OFDM symbol length of each sub-slot or the number of REs in each sub-slot is different, how RE mapping with intra-slot frequency hopping is performed has not been determined.

### CITATION LIST

### Non-Patent Reference

[Non-Patent Reference 1] 3GPP, TS 36.211 V 14.4.0
[Non-Patent Reference 2] 3GPP, TS 36.213 V 14.4.0

### SUMMARY

One or more embodiments of the invention relate to a wireless communication method including performing, with a user equipment (UE), resource element (RE) mapping with frequency hopping. Multiple code blocks (CBs) are mapped to REs in a first sub-slot and a second sub-slot in accordance with a ration of a first sub-slot length of the first sub-slot to a second sub-slot length of the second sub-slot. The first and second sub-slot lengths are a number of Orthogonal Frequency-Division Multiplexing (OFDM) symbols that can multiplex a Physical Uplink Shared Channel (PUSCH). The first and second sub-slot lengths are a number of REs that can multiplex a PUSCH. Each of the multiple CBs is continuously mapped to the REs in a same OFDM symbol. Different CBs are mapped to the REs in a same OFDM symbol.

One or more embodiments of the invention relate to a user equipment (UE) that includes a processor that performs resource element (RE) mapping with frequency hopping. Multiple code blocks (CBs) are mapped to REs in a first sub-slot and a second sub-slot in accordance with a ration of a first sub-slot length of the first sub-slot to a second sub-slot length of the second sub-slot. The first and second sub-slot lengths are a number of Orthogonal Frequency-Division Multiplexing (OFDM) symbols that can multiplex a Physical Uplink Shared Channel (PUSCH). The first and second sub-slot lengths are a number of REs that can multiplex a PUSCH. Each of the multiple CBs is continuously mapped to the REs in a same OFDM symbol. Different CBs are mapped to the REs in a same OFDM symbol.

Other embodiments and advantages of the present invention will be recognized from the description and figures.

### BRIEF DESCRIPTION OF THE DRAWINGS

FIGS. 1A-1C are diagrams showing a scheme of resource element (RE) mapping with frequency hopping according to the conventional technologies.

FIGS. 2A and 2B are diagrams showing a scheme of RE mapping with frequency hopping according to the conventional technologies.

FIG. 3 is a diagram showing a configuration of a wireless communication system according to one or more embodiments of the invention.

FIG. 4 is a diagram for explaining code block (CB) segmentation according to one or more embodiments of the present invention.

FIGS. 5A and 5B are diagrams for explaining an example of a configuration of sub-slots and a sub-slot length according to one or more embodiments of the present invention.

FIG. 6 is a diagram showing another example of a sub-slot length according to one or more embodiments of the present invention.

FIG. 7 is a diagram showing a scheme of RE mapping with frequency hopping according to one or more embodiments of a first example of the present invention.

FIG. 8 is a diagram showing a scheme of RE mapping with frequency hopping according to one or more embodiments of a second example of the present invention.

FIG. 9 is a diagram showing a scheme of RE mapping with frequency hopping according to one or more embodiments of a third example of the present invention.

FIG. 10 is a flowchart showing an operation example of RE mapping according to one or more embodiments of the invention.

FIG. 11 shows a schematic configuration of a TRP according to one or more embodiments of the present invention.

FIG. 12 shows a schematic configuration of an UE according to one or more embodiments of the present invention.

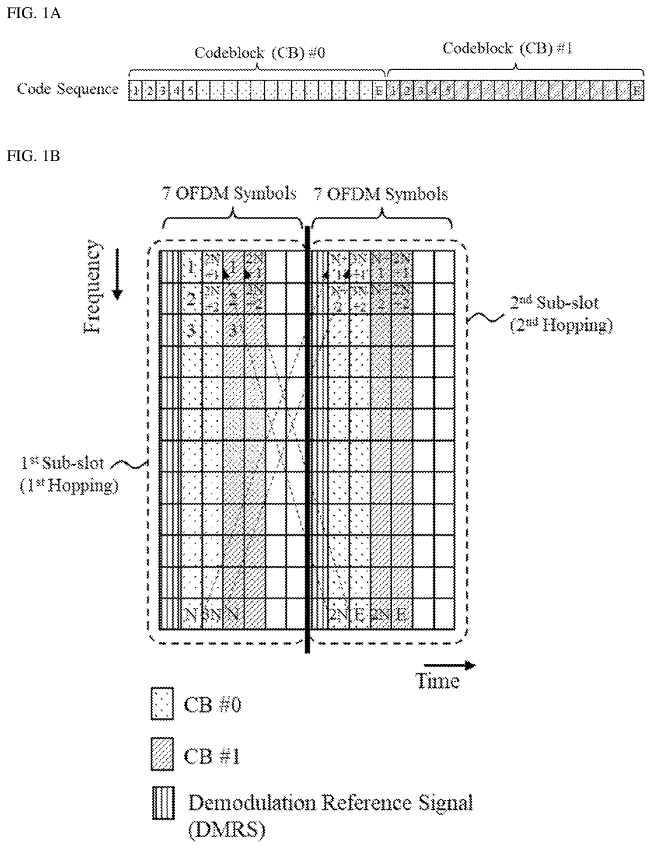

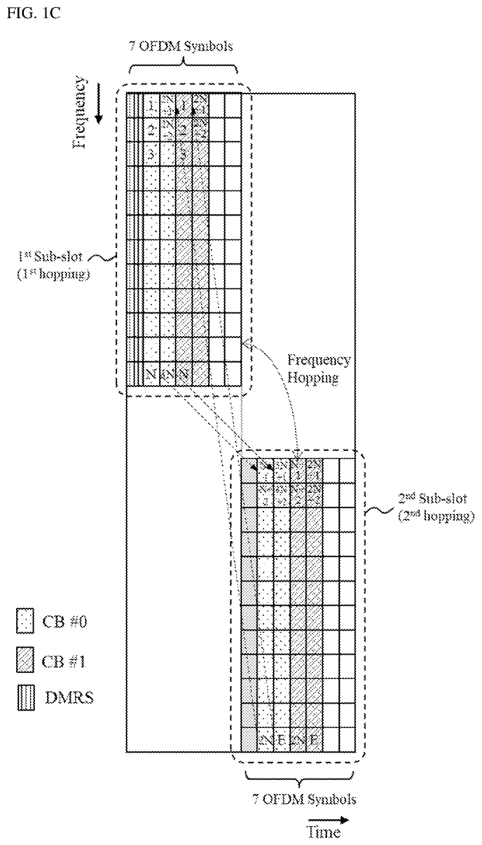

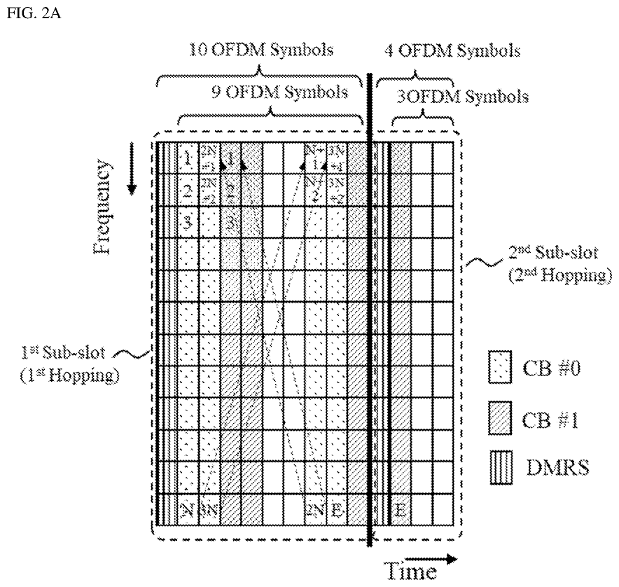

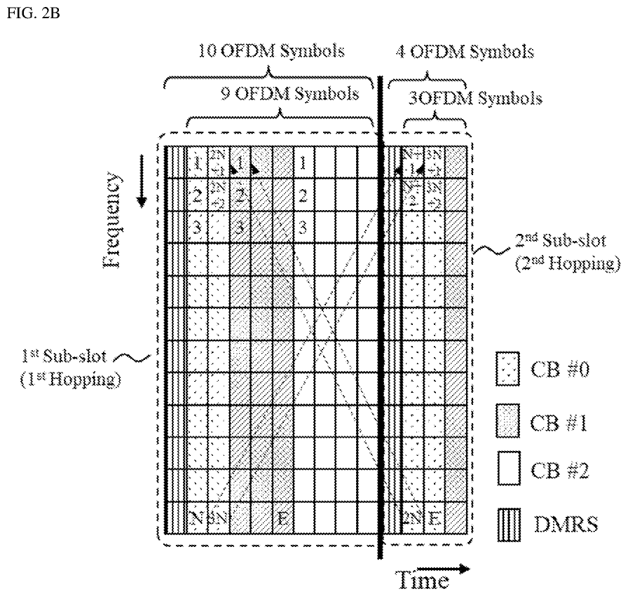

### DETAILED DESCRIPTION

Embodiments of the present invention will be described in detail below, with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

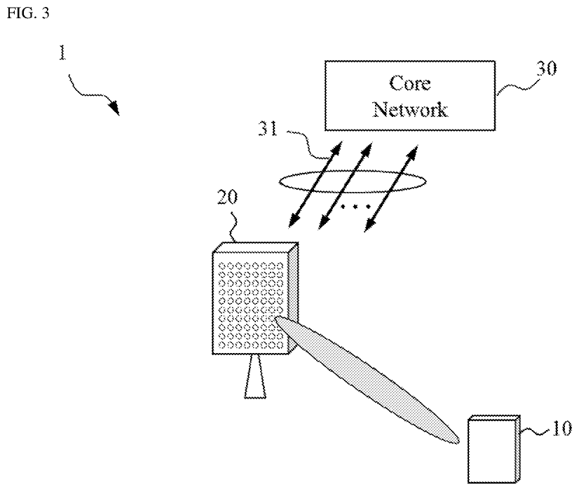

FIG. 3 is a diagram showing a wireless communications system 1 according to one or more embodiments of the invention. The wireless communication system 1 includes a user equipment (UE) 10, a base station (BS) 20, and a core network 30. The wireless communication system 1 may be an NR system. The wireless communication system 1 is not limited to the specific configurations described herein and may be any type of wireless communication system such as an LTE/LTE-Advanced (LTE-A) system.

The BS 20 may communicate uplink (UL) and downlink (DL) signals with the UE 10 in a cell of the BS 20. The DL and UL signals may include control information and user data. The BS 20 may communicate DL and UL signals with the core network 30 through backhaul links 31. The BS 20 may be referred to as a base station (BS). The BS 20 may be gNodeB (gNB).

The BS 20 includes antennas, a communication interface to communicate with an adjacent BS 20 (for example, X2 interface), a communication interface to communicate with the core network 30 (for example, S1 interface), and a Central Processing Unit (CPU) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous BSs 20 may be disposed so as to cover a broader service area of the wireless communication system 1.

The UE 10 may communicate DL and UL signals that include control information and user data with the BS 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a Random Access Memory (RAM), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

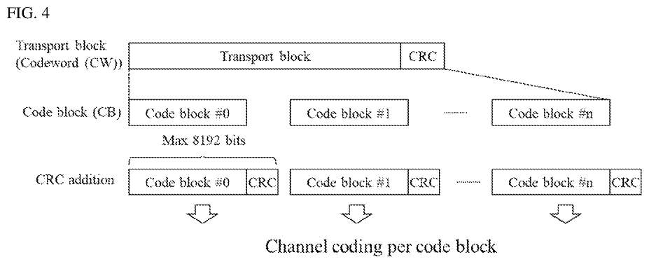

In one or more embodiments of the invention, the UE 10 may generate codewords (CWs) by dividing transmission data. The CW is a data stream after channel coding process. The CW may be used as a unit of re-transmission or link adaptation under HARQ process. Additionally, as shown in FIG. 4, the UE 10 may generate one or more code blocks (CBs) by dividing the CW, which may also be used as a unit of re-transmission. In the NR system, the UE may perform HARQ process for each CW (CW-level HARQ) or for each CB (CBG-level HARQ).

Based on the generated CBs, the UE 10 may perform RE mapping to multiple layers, frequency resources, and time resources for PUSCH transmission. For example, the frequency resources may be subcarriers, and the time resources may be Orthogonal Frequency-Division Multiplexing (OFDM) symbols such as DFT-Spread-OFDM symbols. Transmission quality (diversity gains) may be different depending on mapping order of the multiple layers, the frequency resources, and the time resources.

According to one or more embodiments of the present invention, in PUSCH transmission, RE mapping with frequency hopping may be performed in accordance with a ratio of multiple sub-slot lengths. In frequency hopping, a single slot is divided into multiple sub-slots.

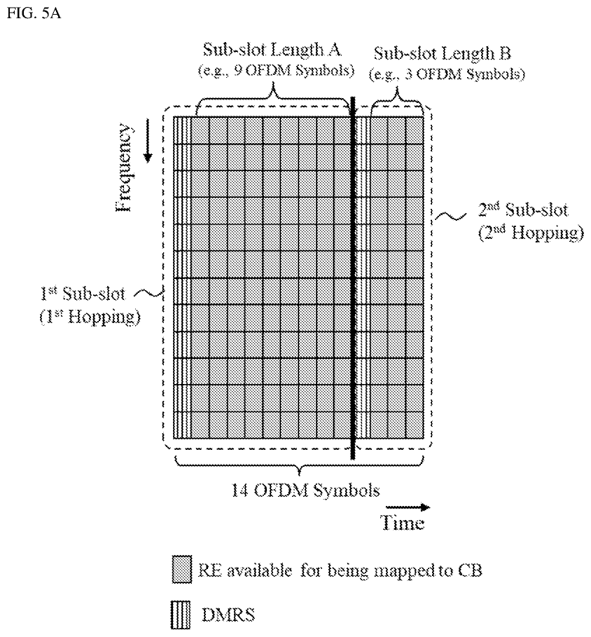

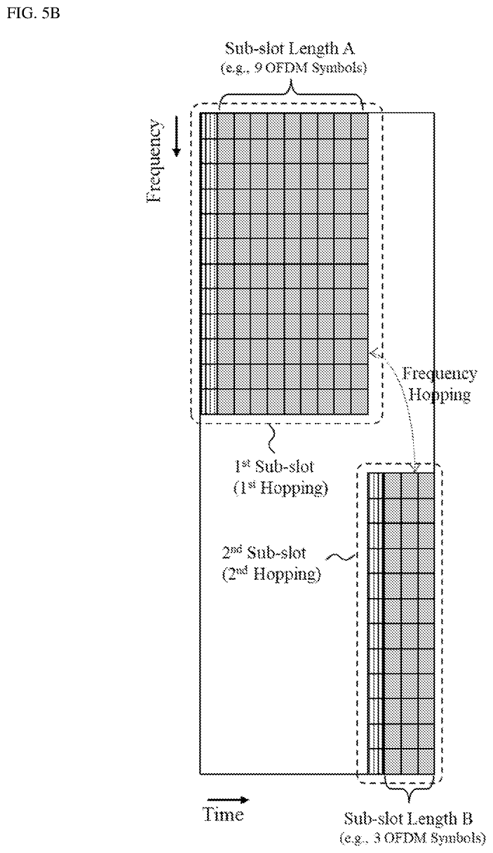

FIGS. 5A and 5B are diagrams for explaining a configuration of sub-slots and a sub-slot length according to one or more embodiments of the present invention.

In FIGS. 5A and 5B, a horizontal axis represents a time (OFDM symbol) axis, a vertical axis represents a frequency (subcarrier) axis, and each block represents an RE. For example, the number of the OFDM symbols in a time axis direction of a single slot is 14. As shown in FIGS. 5A and 5B, a single slot is divided into two sub-slots (first and second sub-slots) in RE mapping with frequency hopping.

In one or more embodiments of the present invention, as shown in FIGS. 5A and 5B, the sub-slot length may be the number of OFDM symbols in which the REs are available for being mapped to the multiple CBs. In other words, the sub-slot length may be the number of OFDM symbols that can multiplex the PUSCH. As another example, the sub-slot length may be defined as the number of OFDM symbols in which all REs is included in each sub-slot.

In an example of FIGS. 5A and 5B, a sub-slot length A of the first sub-slot may be 9 OFDM symbols and a sub-slot length B of the second sub-slot may be 3 OFDM symbols. Thus, a ratio of the sub-slot length A to the sub-slot length B is three to one (3:1).

The first and second sub-slots in FIG. 5B indicates a slot configuration where the first and second sub-slots in FIG. 5A are hopped in a frequency axis direction. To simplify the explanation of methods of RE mapping with frequency hopping, one or more embodiments of the present invention will be described below using a diagram such as FIG. 5A.

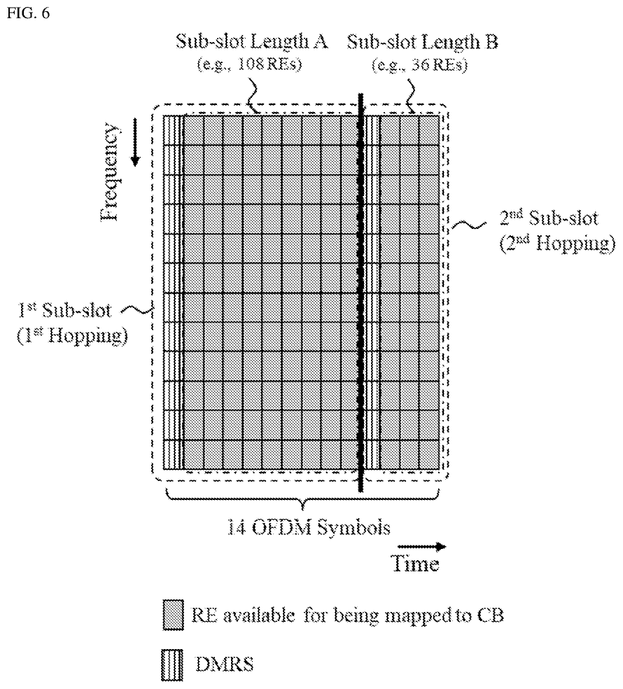

As another example, as shown in FIG. 6, the sub-slot length may be defined as the number of REs available for being mapped to the CBs in each sub-slot. In other words, the sub-slot length may be the number of REs that can multiplex the PUSCH. Furthermore, the sub-slot length may be defined as the number of all REs in each sub-slot.

In an example of FIG. 6, when each sub-slot includes 12 subcarriers in the frequency axis direction, a sub-slot length A of the first sub-slot may be 108 REs and a sub-slot length B of the second sub-slot may be 36 REs. Thus, a ratio of the sub-slot length A to the sub-slot length B is three to one (3:1).

### First Example

In a method of RE mapping with frequency hopping according to one or more embodiments of a first example of the present invention, multiple CBs may be mapped in accordance with a ratio of multiple sub-slot lengths and the REs in the same OFDM symbol may be continuously mapped. Thus, in one or more embodiments of a first example of the present invention, the order of RE mapping may be changed.

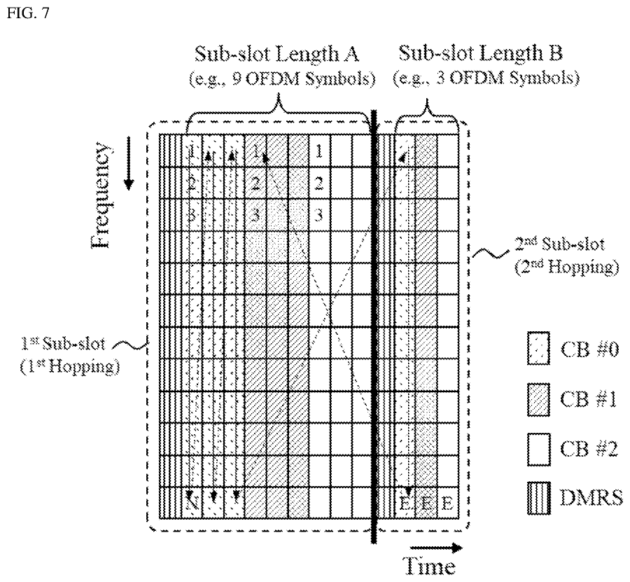

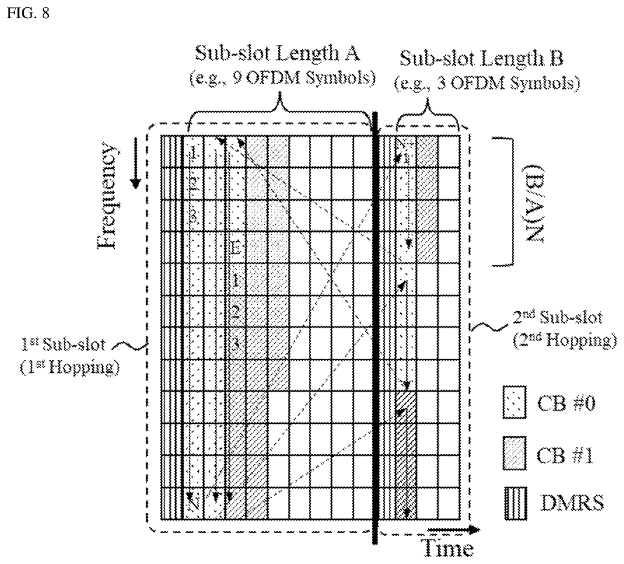

In an example of FIG. 7, the three CBs (CBs #0, #1, and #2) may be mapped to the REs in both of the first and second sub-slots. In FIG. 7, the sub-slot length A is greater than the sub-slot length B. For example, the sub-slot length A of the first sub-slot may be 9 OFDM symbols and the sub-slot length B of the second sub-slot may be 3 OFDM symbols. Thus, a ratio of the sub-slot length A to the sub-slot length B is three to one (3:1).

As shown in FIG. 7, the REs may be mapped so that a ratio of the number of REs mapped to each CB in the first sub-slot to the number of REs mapped to each CB in the second sub-slot is equal to a ratio of the sub-slot length A to the sub-slot length B, that is, three to one.

Furthermore, each CB is mapped to the REs in each of (sub-slot length) A/B OFDM symbols, and then mapped to the REs in the second sub-slot having shorter sub-slot length (sub-slot length B). In other words, when t (=1˜(A+B)) represents an index of a time axis direction, the method of RE mapping is indicated as the following formula:

If t=(A+B)n/B, mapping to REs in a sub-slot having a shorter sub-slot length; and

else, mapping to REs in a sub-slot having a longer sub-slot length.

According to one or more embodiments of the first example of the present invention, even if the two sub-slot lengths are different from each other, all of the CBs may be mapped to the REs in both of the multiple sub-slots. As a result, frequency diversity gain can be achieved for all of the CBs.

### Second Example

In a method of RE mapping with frequency hopping according to one or more embodiments of a second example of the present invention, multiple CBs may be mapped in accordance with a ratio of multiple sub-slot lengths and different CBs may be mapped to the REs in the same OFDM symbol. Thus, in one or more embodiments of a second example of the present invention, a mapping length (the number of mapped REs) may be changed.

In one or more embodiments of the second example of the present invention, for example, it is assumed that there are four CBs (CBs #0, #1, #2, and #3). In an example of FIG. 8, CBs #2 and #3 are omitted to simplify the explanation. As shown FIG. 8, all of the CBs may be mapped to the REs in both of the first and second sub-slots. In FIG. 8, the sub-slot length A is greater than the sub-slot length B. For example, the sub-slot length A of the first sub-slot may be 9 OFDM symbols and the sub-slot length B of the second sub-slot may be 3 OFDM symbols. Thus, a ratio of the sub-slot length A to the sub-slot length B is three to one (3:1).

As shown in FIG. 8, the REs may be mapped so that a ratio of the number of REs mapped to each CB in the first sub-slot to the number of REs mapped to each CB in the second sub-slot is equal to a ratio of the sub-slot length A to the sub-slot length B, that is, three to one.

Furthermore, REs in the first sub-slot having a longer sub-slot length (sub-slot length A) and REs in the second sub-slot having a shorter sub-slot length (sub-slot length B) may be alternately mapped. In the first sub-slot having the longer sub-slot length, the CB may be mapped to REs corresponding to N subcarriers in the same OFDM symbol. In the second sub-slot having the shorter sub-slot length, the CB may be mapped to REs corresponding to (B/A)*N subcarriers. Thus, all of the CBs may be approximately equally mapped to the REs in both of the first and second sub-slots.

According to one or more embodiments of the second example of the present invention, frequency diversity gain can be achieved for all of the CBs.

### Third Example

In a method of RE mapping with frequency hopping according to one or more embodiments of a third example of the present invention, multiple CB s may be mapped in accordance with a ratio of multiple sub-slot lengths and different CBs may be mapped to the REs in the same OFDM symbol. Thus, in one or more embodiments of a second example of the present invention, a mapping length (the number of mapped REs) may be changed.

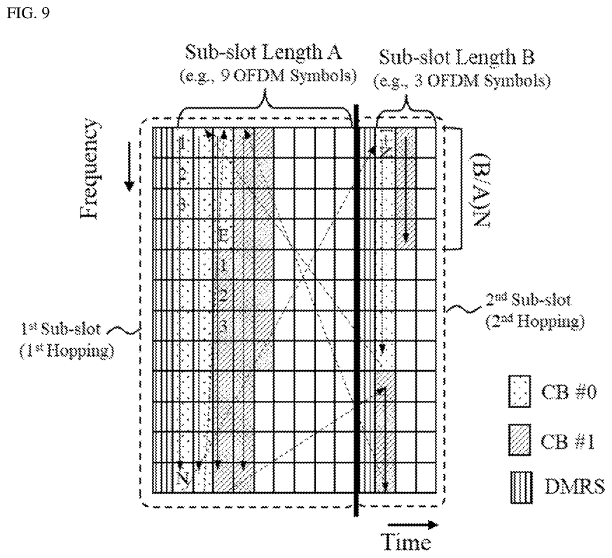

In one or more embodiments of the third example of the present invention, for example, it is assumed that there are four CBs (CBs #0, #1, #2, and #3). In an example of FIG. 9, CBs #2 and #3 are omitted to simplify the explanation. As shown FIG. 9, all of the CBs may be mapped to the REs in both of the first and second sub-slots. In FIG. 9, the sub-slot length A is greater than the sub-slot length B. For example, the sub-slot length A of the first sub-slot may be 9 OFDM symbols and the sub-slot length B of the second sub-slot may be 3 OFDM symbols. Thus, a ratio of the sub-slot length A to the sub-slot length B is three to one (3:1).

As shown in FIG. 9, the REs may be mapped so that a ratio of the number of REs mapped to each CB in the first sub-slot to the number of REs mapped to each CB in the second sub-slot is equal to a ratio of the sub-slot length A to the sub-slot length B, that is, three to one.

In one or more embodiments of the third example of the present invention, the maximum number (R₁) of REs that can be mapped in the first sub-slot and the maximum number (R₂) of REs that can be mapped in the second sub-slot may be calculated based on the ratio of the sub-slot length A to the sub-slot length B in advance (R₁:R₂=A:B). Then, the REs in the first sub-slot having a longer sub-slot length (sub-slot length A) and REs in the second sub-slot having a shorter sub-slot length (sub-slot length B) may be alternately mapped. In the first sub-slot having the longer sub-slot length, the CB may be mapped to REs corresponding to N subcarriers. In the second sub-slot having the shorter sub-slot length, the CB may be mapped to REs corresponding to N subcarriers. The REs in one sub-slot are mapped in one OFDM symbol, and then the REs in the other sub-slot are mapped. Furthermore, when the number of REs mapped in each sub-slot has reached the maximum number (R₁, or R₂), the RE mapping in one sub-slot for the CB may be stopped, and then the RE mapping in the other sub-slot for the CB may be performed. Thus, all of the CBs may be approximately equally mapped to the REs in both of the first and second sub-slots.

According to one or more embodiments of the third example of the present invention, frequency diversity gain can be achieved for all of the CBs.

According to one or more embodiments of another example of the present invention, RE mapping with frequency hopping may be performed so that the number of REs mapped to multiple CBs in each sub-slot is (approximately) equal.

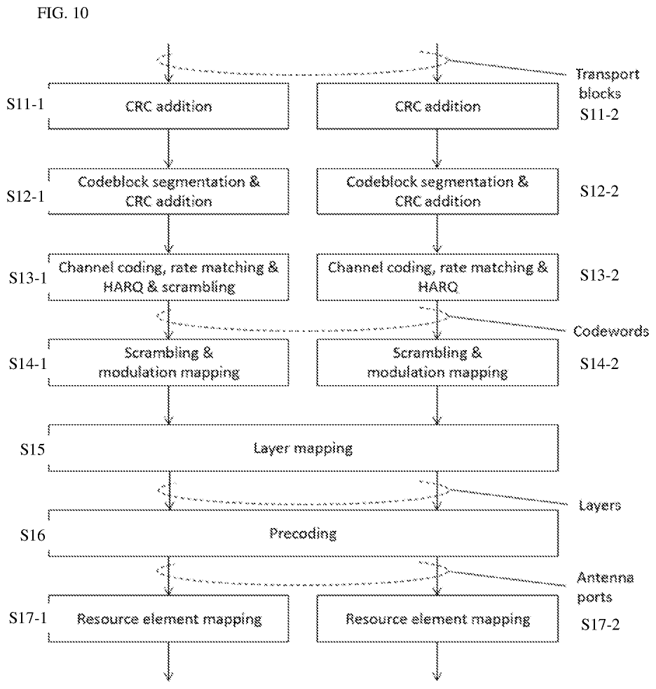

FIG. 10 shows a flowchart of an operation example of RE mapping according to one or more embodiments of the invention.

As shown in FIG. 10, at step S11-1 (S11-2), the UE 10 adds a CRC to a transport block. At step S12-1 (S12-2), the UE 10 performs CB segmentation and CRC addition so that the length of each CB matches a predetermined length specified by the 3GPP standard. At step S13-1 (S13-2), the UE 10 performs channel coding; rate matching; HARQ processing; and scrambling for the generated CB. At step S14-1 (S14-2), the UE 10 performs scrambling and modulation mapping.

At step S15, the UE 10 performs layer mapping for the CBs. In one or more embodiments of the invention, the UE 10 may determine which scheme is applied for RE mapping at this step. For example, the UE may choose one of the above schemes according to a signal from a gNB. Alternatively, the UE may apply one of the above schemes in a static manner. Subsequently, the UE 10 may perform precoding at S16, and then perform RE mapping according to the selected scheme at S17-1 (S17-2). In one or more embodiments of the invention, the UE 10 may determine which scheme is applied for RE mapping at this step.

(Configuration of BS)

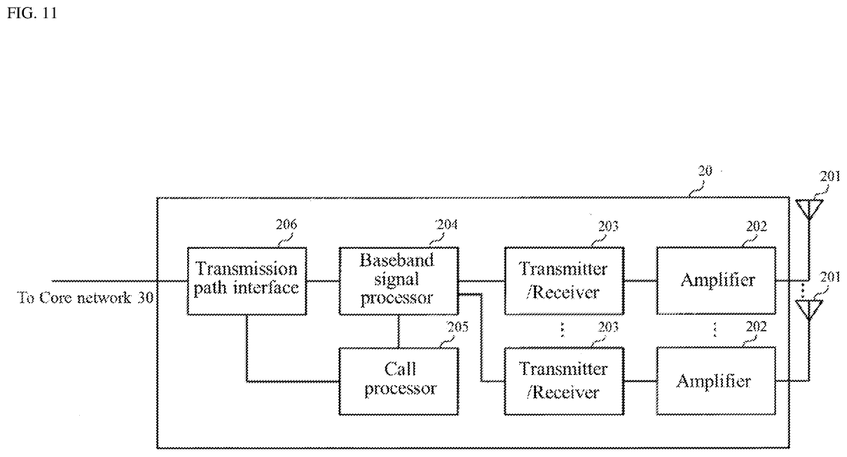

The BS 20 according to one or more embodiments of the invention will be described below with reference to FIG. 11. FIG. 11 shows a schematic configuration of the BS 20 according to one or more embodiments of the invention. The BS 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the BS 20 to the UE 20 is input from the core network 30, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., RRC signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the BS 20, radio frequency signals are received in each antenna 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network 30 through the transmission path interface 206. The call processor 205 performs call processing such as setting up and releasing a communication channel, manages the state of the BS 20, and manages the radio resources.

(Configuration of User Equipment)

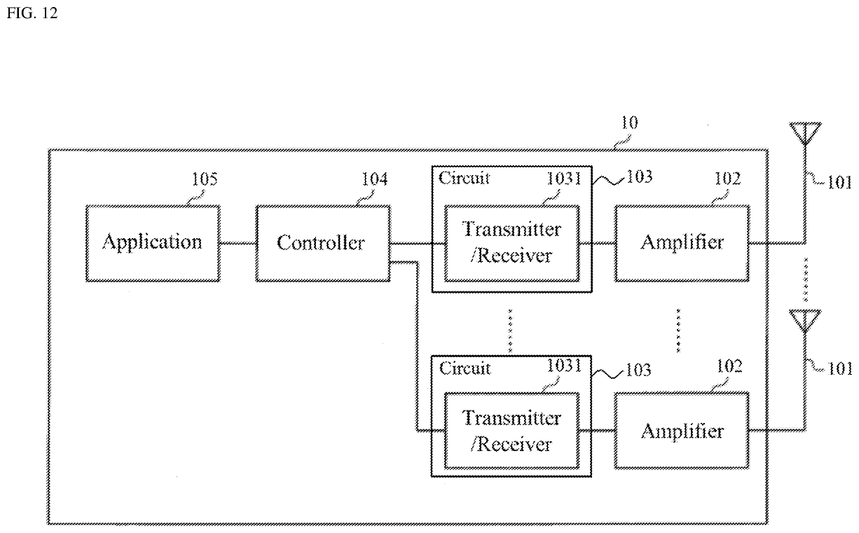

The UE 10 according to one or more embodiments of the invention will be described below with reference to FIG. 12. FIG. 12 shows a schematic configuration of the UE 10 according to one or more embodiments of the invention. The UE 10 has a plurality of UE antennas 101, amplifiers 102, the circuit 103 comprising transceiver (transmitter/receiver) 1031, the controller 104, and an application 105.

As for DL, radio frequency signals received in the UE antennas 101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

One or more embodiments of the present invention may be used for each of the uplink and the downlink independently. One or more embodiments of the present invention may be also used for both of the uplink and the downlink in common.

Although the present disclosure mainly described examples of a channel and signaling scheme based on NR, the present invention is not limited thereto. One or more embodiments of the present invention may apply to another channel and signaling scheme having the same functions as NR such as LTE/LTE-A and a newly defined channel and signaling scheme.

The above examples and modified examples may be combined with each other, and various features of these examples can be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A wireless communication method comprising:
performing, with a user equipment (UE), resource element (RE) mapping with frequency hopping,
wherein multiple code blocks (CBs) are mapped to REs in a first sub-slot and a second sub-slot in accordance with a ration of a first sub-slot length of the first sub-slot to a second sub-slot length of the second sub-slot.

2. The wireless communication method according to claim 1, wherein the first and second sub-slot lengths are a number of Orthogonal Frequency-Division Multiplexing (OFDM) symbols that can multiplex a Physical Uplink Shared Channel (PUSCH).

3. The wireless communication method according to claim 1, wherein the first and second sub-slot lengths are a number of REs that can multiplex a PUSCH.

4. The wireless communication method according to claim 1, wherein each of the multiple CBs is continuously mapped to the REs in a same OFDM symbol.

5. The wireless communication method according to claim 1, wherein different CBs are mapped to the REs in a same OFDM symbol.

6. A user equipment (UE) comprising:
a processor that performs resource element (RE) mapping with frequency hopping,
wherein multiple code blocks (CBs) are mapped to REs in a first sub-slot and a second sub-slot in accordance with a ration of a first sub-slot length of the first sub-slot to a second sub-slot length of the second sub-slot.

7. The UE according to claim 6, wherein the first and second sub-slot lengths are a number of Orthogonal Frequency-Division Multiplexing (OFDM) symbols that can multiplex a Physical Uplink Shared Channel (PUSCH).

8. The UE according to claim 6, wherein the first and second sub-slot lengths are a number of REs that can multiplex a PUSCH.

9. The UE according to claim 6, wherein each of the multiple CBs is continuously mapped to the REs in a same OFDM symbol.

10. The UE according to claim 6, wherein different CBs are mapped to the REs in a same OFDM symbol.
